(19) United States
(12) Patent Application Publication
(10) Pub. No.: US 2026/0112983 A1
(43) Pub. Date: Apr. 23, 2026

(54) PLANETARY MAGNETIC MOTOR AND METHOD OF USING THEREOF

(71) Applicant: Peter Alan Will, Yorba Linda, CA (US)

(72) Inventor: Peter Alan Will, Yorba Linda, CA (US)

(21) Appl. No.: 19/333,076

(22) Filed: Sep. 18, 2025

Related U.S. Application Data
(60) Provisional application No. 63/709,944, filed on Oct. 21, 2024.

(51) Int. Cl. H02P 1/40; H02K 1/16; H02K 7/00; H02K 7/116; H02K 16/02

(52) U.S. Cl. CPC H02P 1/40; H02K 1/16; H02K 7/003; H02K 7/116; H02K 16/02; H02P 2209/11

(57) ABSTRACT

A planetary magnetic motor and a method of use thereof is disclosed. The planetary magnetic motor may have a stator and one or more planetary rotor systems. The stator may have a shell body with a plurality of winding sets distributed along the inner surface of such shell body. The planetary rotor system may have a sun gear with an output shaft, a plurality of planet gears coupled around the sun gear, and an outer ring gear. Each planet gear may have a permanent magnet attached where the permanent magnet extends inside the shell body of the stator and is proximate and faces the winding sets. An alternating current may be fed to the winding sets that create alternating magnetic fields that interact with the permanent magnets to rotate the planet gears and the planetary rotor system, in general.

### CROSS-REFERENCE TO RELATED APPLICATIONS

This application claims the benefits of provisional application Ser. No. 63/709,944, filed 2024-Oct.-21, the entire content of which is expressly incorporated herein by reference.

### STATEMENT RE: FEDERALLY SPONSORED RESEARCH/DEVELOPMENT

Not Applicable

### BACKGROUND

The various aspects and embodiments described herein relate to a planetary magnetic motor and method of using thereof.

Electric motors may be used to convert electricity to mechanical energy, force, and torque via a rotational shaft of the electric motor. The rotational shaft of the electric motor may be rotated using electromagnetic forces produced by electric current that is fed to the electric motor. Conventional electric motors may not optimally utilize electric current and to generate electromagnetic forces to produce the desired mechanical output.

Accordingly, there is a need in the art for an improved device, system, and method for electric motors.

### BRIEF SUMMARY

The various embodiments and aspects disclosed herein address the needs discussed above, discussed below and those that are known in the art.

A planetary magnetic motor and a method of use thereof is disclosed. The planetary magnetic motor may have a stator and one or more planetary rotor systems. The stator may have a shell body with a plurality of winding sets distributed along the inner surface of such shell body. The planetary rotor system may have a sun gear with an output shaft, a plurality of planet gears coupled around the sun gear, and an outer ring gear. Each planet gear may have a permanent magnet attached, where the permanent magnet extends inside the shell body of the stator and is proximate to the winding sets. An alternating current may be fed to the winding sets that create alternating magnetic fields that interact with the permanent magnets to rotate the planet gears and the planetary rotor system, in general. The alternating current may be single-phase or multi-phase. The alternating magnetic fields may impose attractive and repulsive forces on the magnetic poles of the permanent magnets attached to the planet gears to rotate them. The rotation of the planet gears by such magnetic forces may be translated to the sun gear having the output shaft in its center. The outer ring gear of the motor may stay stationary during such actuation. The output shaft, rotated by the generated forces created by the alternating magnetic fields, may be coupled to a mechanical device or mechanical system that requires rotational force and torque to operate.

More particularly, a method of actuation of a planetary magnetic motor is disclosed that may include providing a stator having a chamber with a plurality of winding sets distributed around an inner surface of the chamber, providing a planetary rotor system having a central sun gear with an output shaft, a plurality of planet gears coupled around the central sun gear, and a ring gear defining the outer boundary of the planetary rotor system and coupled to the plurality of planet gears, providing a plurality of permanent magnets wherein each permanent magnet has a first magnetic pole and a second magnetic pole and is attached to a planet gear of the plurality of planet gears, the plurality of permanent magnets inside the chamber of the stator and proximate to the winding sets, the first magnetic poles of the plurality of permanent magnets leading in position relative to the second magnetic poles of the plurality of permanent magnets along a revolving path of the plurality of planet gears around the central sun gear, running an electric current in a first direction in the plurality of winding sets such that a first magnetic field is produced that delivers an attractive force to the first magnetic poles of the plurality of permanent magnets and a repulsive force to the second magnetic poles such that the plurality of planets gears are rotated that in turn causes the central sun gear to also rotate and the planet gears to revolve around the central sun gear, the rotation of the plurality of planet gears changing positions of the first magnetic poles relative to the second magnetic poles of the plurality of permanent magnets such that the second magnetic poles are leading in position along the revolving path of the plurality of planet gears and the first magnetic poles are trailing in position, and running the electric current in a second direction in the plurality of winding sets such that a second magnetic field is produced that delivers an attractive force to the second magnetic poles of the plurality of permanent magnets and a repulsive force to the first magnetic poles such that the plurality of planets gears are further rotated that causes the central sun gear to also in turn further rotate and the planet gears to further revolve around the central sun gear.

In some embodiments, the plurality of planet gears revolve around the central sun gear in a same direction as the central sun gear rotates.

In some embodiments, the ring gear remains stationary during actuation of the planetary magnetic motor.

In some embodiments, the chamber of the stator has a plurality of convex projections along an outer boundary of the chamber and each winding set occupies a convex projection of the plurality of convex projects.

In some embodiments, the plurality of winding sets each comprise a plurality of winding subsets that are spaced apart from each other.

In some embodiments, the electric current has an alternating square wave form.

In some embodiments, the electric current has an alternating sinusoidal wave form.

Furthermore, a planetary magnetic motor is disclosed that may include a stator having a stator body with a first open end opening to a central cavity that extends along a length of the stator body, the central cavity having an outer boundary and a center within the stator body, a plurality of winding sets distributed around the outer boundary of the central cavity of the stator body, the plurality of winding sets configured to receive alternating electric current and produce alternating magnetic fields, a planetary rotor system proximate to the first open end of the stator body, the planetary rotor system comprising, a sun gear being central of the planetary rotor system by positioned proximate to the center of the central cavity, a plurality of planet gears coupled around the sun gear and facing the plurality of winding sets of the stator, a ring gear coupled to the plurality of the planet gears, the ring gear defining an outer boundary of the planetary rotor system, an output shaft attached in the middle of the sun gear, and a plurality of permanent magnets, each permanent magnet extending inside the central cavity of the stator body and having a lateral side attached to one of the plurality of planet gears, and each permanent magnet having a first magnetic pole proximate to a first width end of the permanent magnet and a second magnetic pole proximate to a second width end of the permanent magnet, the first and second magnetic poles of each permanent magnet being proximate to the plurality of winding sets and configured to experience magnetic forces from the alternating magnetic fields that the winding sets are configured to generate and to rotate the planetary rotor system.

In some embodiments, the stator body has a plurality of convex projections along the outer boundary of the central cavity and each winding set occupies a convex projection of the plurality of convex projects.

In some embodiments, the plurality of winding sets each comprise a plurality of winding subsets that are spaced apart from each other.

In some embodiments, the planetary rotor system is a first planetary rotor system and the planetary magnetic motor further comprises a second planetary rotor system proximate to a second open end of the stator body opening to the central cavity.

In some embodiments, the output shaft of the first planetary rotor system extends within the central cavity and the length of the stator body and is attached to a sun gear of the second planetary rotor system.

In some embodiments, the alternating electric current that the plurality of winding sets are configured to receive is a three-phase alternating current.

In some embodiments, the plurality of planet gears include four planet gears symmetrically spaced apart from each other around the sun gear.

In some embodiments, the magnetic forces that the first and second magnetic poles of each permanent magnet are configured to experience from the alternating magnetic fields include both an attractive force and a repulsive force.

Additionally, a method of actuation of a planetary magnetic motor is disclosed that may include providing a stator having a chamber with a plurality of winding sets distributed around an inner surface of the chamber, providing a planetary rotor system having a central sun gear with an output shaft, a plurality of planet gears coupled around the central sun gear, and a ring gear defining the outer boundary of the planetary rotor system and coupled to the plurality of planet gears, providing a plurality of permanent magnets wherein each permanent magnet is attached to a planet gear of the plurality of planet gears and inside the chamber of the stator and proximate to the winding sets, running an electric current in a first direction in the plurality of winding sets such that a first magnetic field is produced creating magnetic forces that are acted upon the plurality of permanent magnets that rotate the plurality of planets gears that in turn causes the central sun gear to also rotate, the plurality of planet gears also revolving around the central sun gear, and running the electric current in a second direction in the plurality of winding sets such that a second magnetic field is produced creating magnetic forces that are acted upon the plurality of permanent magnets that further rotate the plurality of planets gears that in turn causes the central sun gear to also further rotate, the plurality of planet gears also further revolving around the central sun gear.

In some embodiments, the magnetic forces created by the first and second magnetic fields include both attractive forces and repulsive forces.

In some embodiments, lateral sides of the plurality of permanent magnets are attached to the plurality of planet gears.

In some embodiments, the plurality of permanent magnets each have a first magnetic pole proximate to a first width end and a second magnetic pole proximate to a second width end of each permanent magnet.

In some embodiments, the electric current has an alternating square wave form.

In some embodiments, the electric current is a three-phase electric current.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a perspective view of the planetary magnetic motor;

FIG. 2A shows the internal components of the planetary magnetic motor of FIG. 1;

FIG. 2B shows some of the internal components of the planetary magnetic motor of FIG. 2A removed for a better view of other internal components;

FIGS. 3A-E are a front view of FIG. 2B and illustrate how the gears and output shaft are rotated based on the magnetic interaction between the permanent magnets and the winding sets having electric current;

FIG. 4A shows a front view similar to FIGS. 3A-E but with the planetary magnetic motor having different winding subsets;

FIG. 4B shows a perspective view of the planetary magnetic motor of FIG. 4A;

FIG. 4C shows a close-up view of portions of the winding sets of the planetary magnetic motor of FIG. 4B and how they are connected to each other;

FIG. 5 shows another embodiment of the planetary magnetic motor wherein the outer ring gear rotates and the winding sun planet remains stationary; and

FIGS. 6A-C show different alternating current graphs that may be used to run current in the winding sets of the planetary magnetic motor.

### DETAILED DESCRIPTION

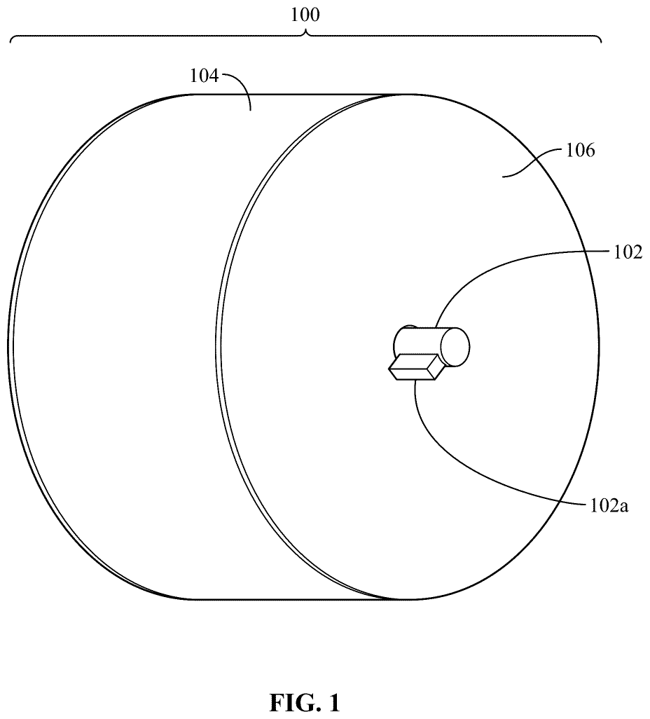

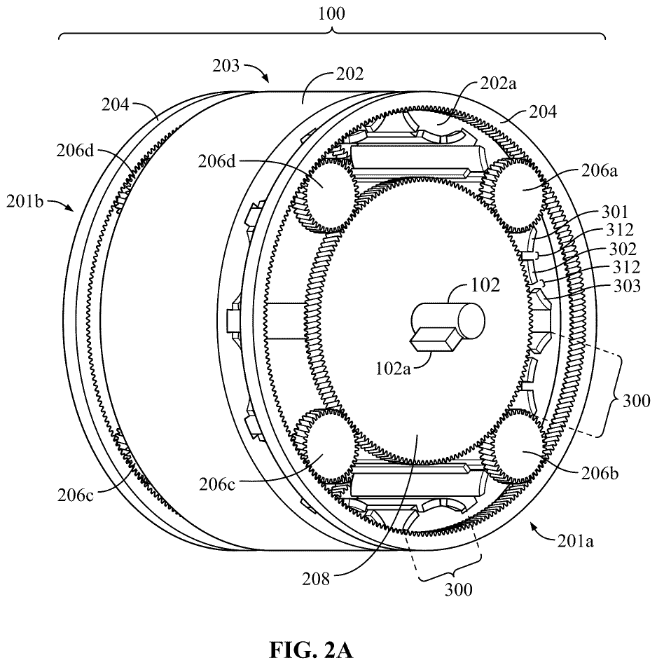

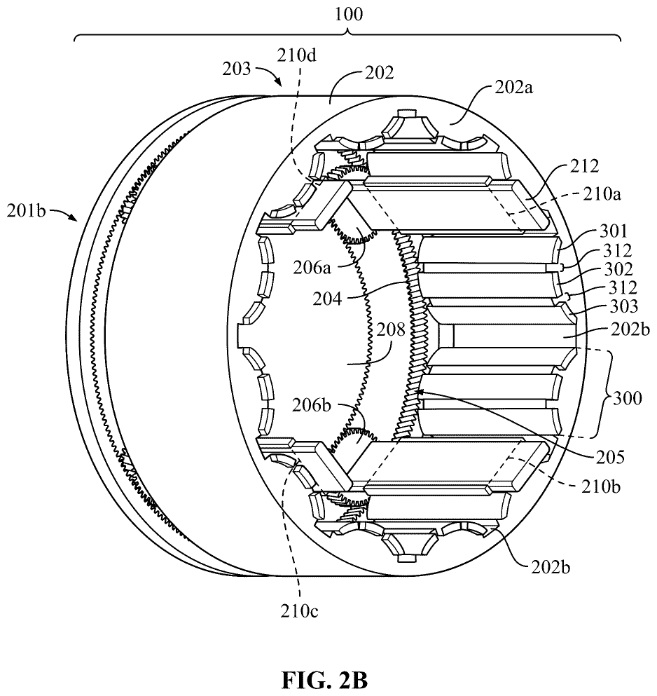

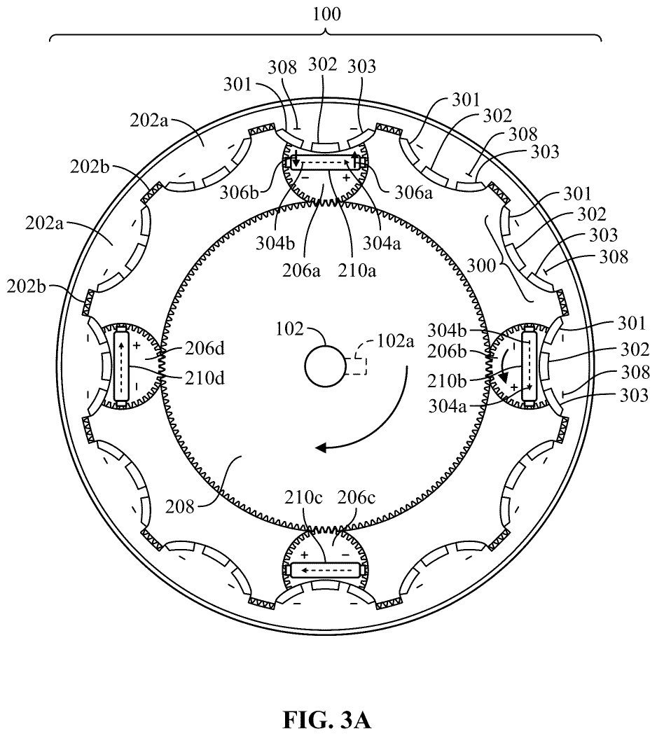

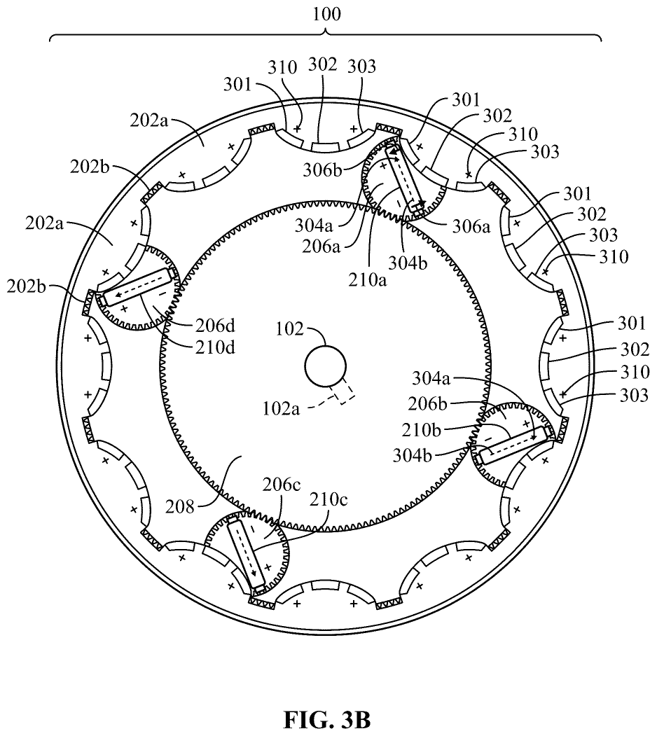

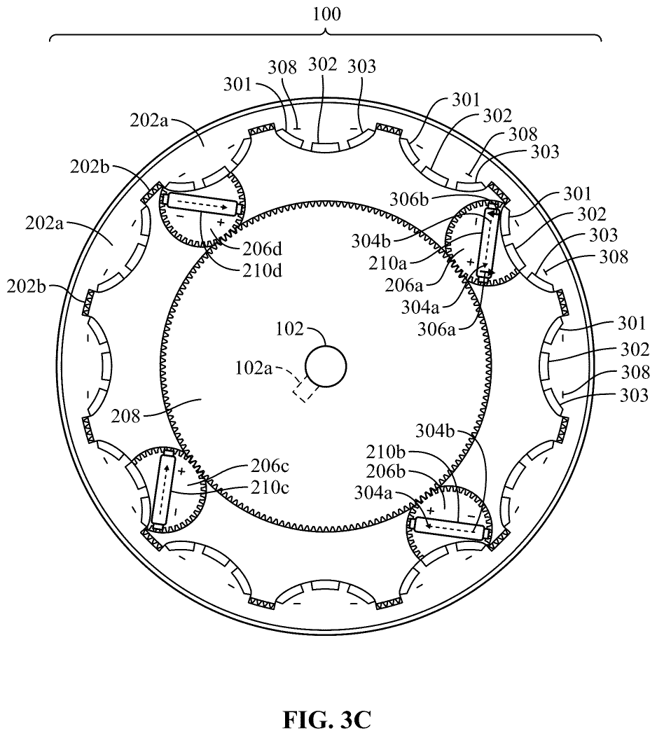

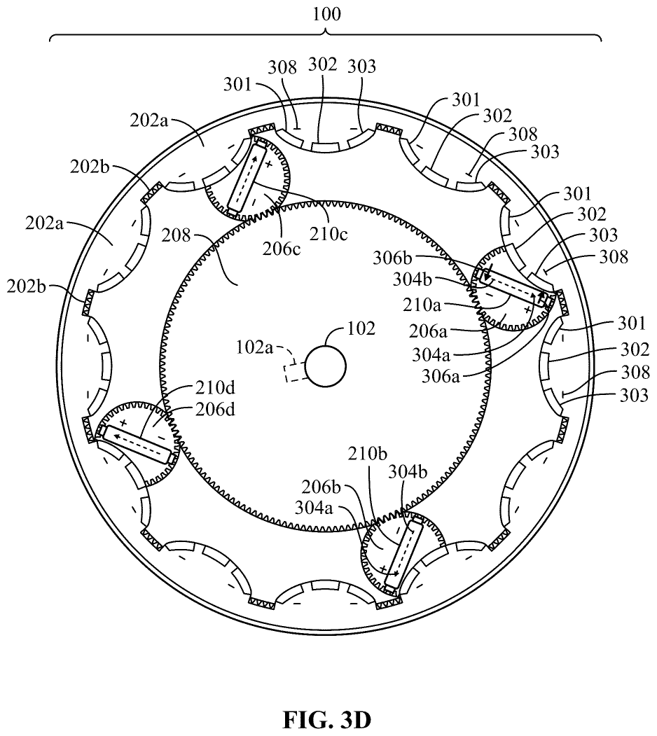

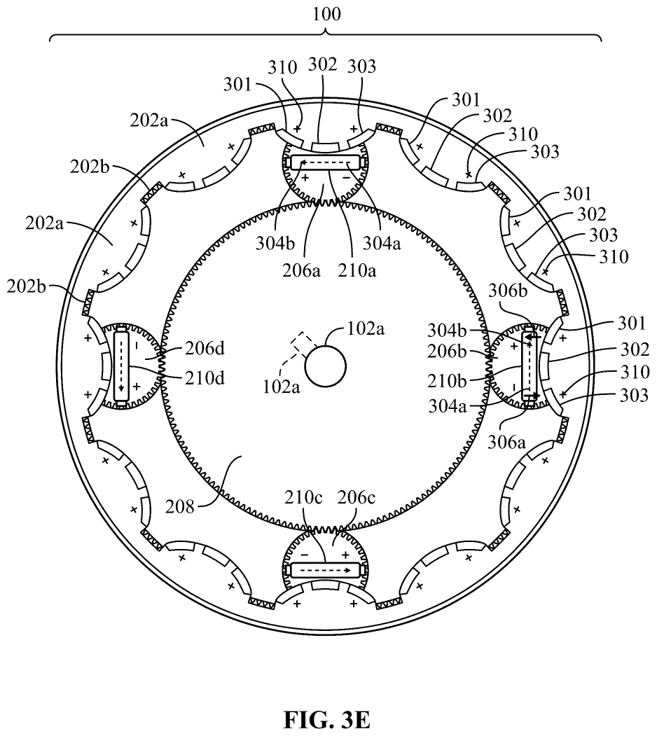

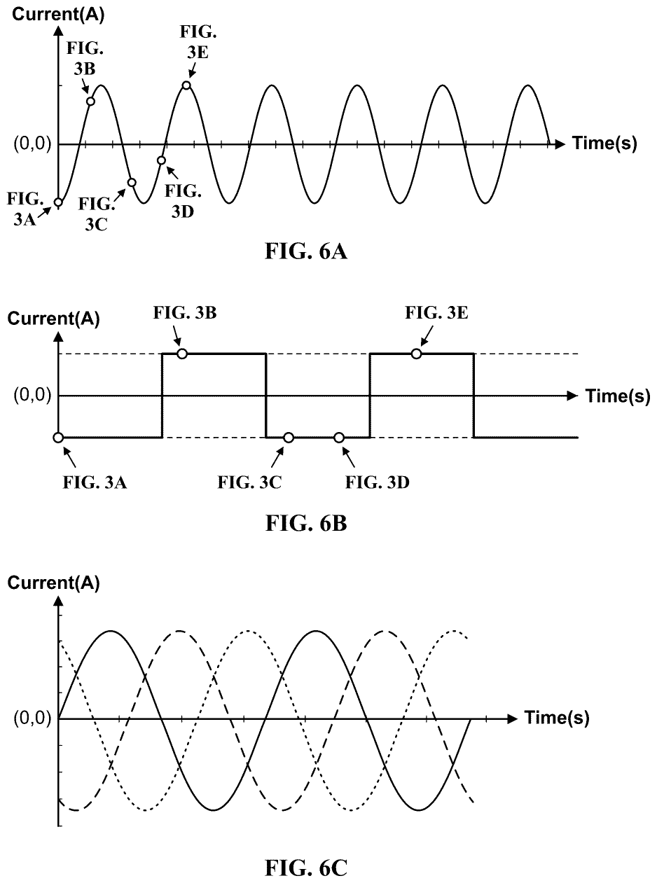

Referring now to the Figures, a planetary magnetic motor 100 is shown having a rotatable output shaft 102 (see FIG. 1) extending out of a housing 104 (see FIG. 1). As shown in FIG. 2A, the output shaft 102 may be attached in the center of a sun gear 208 that is part of a planetary rotor system 201a. The planetary rotor system 201a may also have a plurality of planet gears 206a-d coupled around the sun gear 208, and an outer ring gear 204 coupled to the planet gears 206a-d and defining the outer boundary of the rotor system. The planetary magnetic motor 100 may have a second planetary rotor system 201b the same as the first planetary rotor system 201a. The two planetary rotor systems 201a-b may have a stator 203 therebetween. As shown in FIG. 2B, the stator 203 may have a shell body 202 that has a plurality of winding sets 303 distributed along the inner surface of the cavity 205 of the shell body 202. As shown in FIGS. 3A-E, the plurality of winding sets 303 may have alternating current run through them such that magnetic fields are produced to interact and provide force on permanent magnets 210a-d that are attached to the planet gears 206a-d. The magnetic forces generated by the magnetic fields of the current running through the winding sets 300 may attract and repel the magnetic poles 304a-b of the permanent magnets 210a-d and may create rotational motion on the planet gears 206a-d. The rotational motion of the planet gears 206a-d may be translated to the sun gear 208 and the output shaft 102. The output shaft 102 may in turn be coupled to a mechanical device or system to provide rotational force and torque for the operation of such device. The generation of magnetic field by the winding sets 300 for creating the magnetic forces to rotate the gears in FIGS. 3A-E is shown using a single-phase alternating current (see FIGS. 6A-B). However, multiphase alternating currents, such as a three-phase alternating current shown in FIG. 6C, may also be used with the winding sets 300 to generate a magnetic field that rotates the planetary rotor systems 201a-b and the output shaft 102, in general.

Referring now to FIG. 1, a perspective view of the planetary magnetic motor 100 is shown. The internal components of the planetary magnetic motor 100 (see FIG. 2A) may be covered by a cylindrical housing 104 and two end caps 106 covering the circular ends of the housing 104. The cylindrical housing 104 and the two end caps 106 may be made from non-ferrous metallic or non-metallic material.

A rotatable output shaft 102 may extend out of the center of one of the endcaps 106 to couple with a mechanical system requiring rotational force and torque for operation. The rotatable shaft 102 may be coupled to the planetary rotor system inside the housing 104 and be driven and rotated by the magnetic interaction between the planetary rotor system and the stator within the housing 104, as described elsewhere herein. The rotatable shaft 102 may have a shaft skey 102a also extending out of the center of the endcap 106 to engage the mechanical system that may be coupled to the planetary magnetic motor 100.

Referring now to FIG. 2A, a perspective view of the planetary magnetic motor 100 with the housing 104 and endcaps 106 removed is shown. The internal components of the planetary magnetic motor 100 may include a stator 203 and one or more planetary rotor system 201a-b. The stator 203 may be between two planetary rotor systems 201a-b where the stator 203 may be configured to create an alternating magnetic field that exerts magnetic forces on a set of permanent magnets 210a-d, which are attached and may be part of the one or more rotor systems 201a-b, to rotate the output shaft 102 to provide rotational force and torque.

Referring specifically to the stator 203 of the planetary magnetic motor 100, the stator 203 may have a cylindrical external surface and a body 202 made from laminated sheet metals. The laminated sheet metals making up the core body 202 of the stator 203 may have circular cross-sections and be stacked next to each other to make up the length of the cylindrical body 202 of the stator 203. The usage of the laminated sheet metals instead of one solid piece for the core body 202 of the stator 203 may reduce the generation of eddy current in such core body 202 when current is run through the winding subsets 301-303 that are attached to the body 202 of the stator 203. The body 202 of the stator 203 may be made from a ferrous material, such as steel or any material having iron, to strengthen the magnetic field and force that the winding subset 301-303 may create when electric current is run through such windings. Alternatively, the body 202 of the stator 203 may be one unitary piece of material.

The body 202 of the stator 203 may also have an internal cavity 205 (see FIG. 2B) extending through the center of the body 202. The internal cavity 205 may carve out the majority of the internal volume of the body 202 of the stator 203 to give such body 202 a cylindrical shell shape. The body 202 of the stator 203 may have a plurality of convex projections 202a distributed circumferentially along the internal surface of the cylindrical shell. As shown in FIG. 2B, the convex projections 202a may project towards the center of the internal cavity 205 in an elliptic or circular curvature. The curvature of each convex projection 202a may extend along the inner length of the cylindrical shell of the stator body 202. The curvature of the convex projections 202a may help create the rotational motion of the planet gears 206a-d, of the one or more planetary rotor system 201a-b, since the winding subsets 301-303 creating the alternating magnetic field may lay on the curved convex projections 202a and rotate the permanent magnets 210a-d along such curved projections.

The convex projections 202a may be spaced apart from each other by stator body grooves 202b between them on the internal surface of the shell body 202. The stator body grooves 202b may extend along the inner length of the cylindrical shell body 202 of the stator 203. The body grooves 202b may be necessary to create a clearance for the permanent magnets 210a-d when such components rotate between the convex projections 202a. Consequently, the body grooves 202b may be wider than the thickness of permanent magnets 210a-d and the casings 212 holding such magnet. The aforementioned thickness may be measured from two opposing lateral faces of the casing 212, or permanent magnet 210a-d, having a rectangular prism shape. In other words, the aforementioned thickness may be measured from the two opposing rectangular planar surfaces of the casings 212 holding the permanent magnets 210a-d, or the planar surface of the permanent magnets 210a-d themselves.

Each convex projection 202a may have a winding set 300 with one or more winding subsets 301-303 attached on the outer curvature of the convex projections 202a. The one or more winding subsets 301-303 of the winding sets 300 may face towards the center of the cylindrical shell of the stator body 202 and its inner cavity 205. The winding sets 300 and subsets 301-303 may create magnetic fields when electric current are run through them for such magnetic fields to interact with the permanent magnets 210a-d attached to the planet gears 206a-d to provide magnetic forces to rotate the planetary rotor systems 201a-b and the output shaft 102, in general. The stator 203 may have between three to 96 winding sets 300 distributed symmetrically and in circle inside the inner cavity 205 of the stator body 202. In some examples, the stator may have greater than 96 winding sets 300.

Each winding subset 301-303 may be made from copper wiring that is wrapped and closely packed together (e.g., no spacing between the wiring loops of the winding subset) to create a coil that may act as an electromagnet when current is run therethrough. By way of example and not limitation, the copper wiring may be replaced with aluminum wiring. To create the winding subsets 301-303, the copper wiring may be wrapped and extend along the length of the convex projections 202a that extend along the inner length of the cylindrical shell of the stator body 202. Each winding subset 301-303 may have between 15 to 50 winding loops of copper wiring closely packed together along the convex projection 202a to make the subset. In some examples, each winding subset 301-303 may have greater than 50 winding loops.

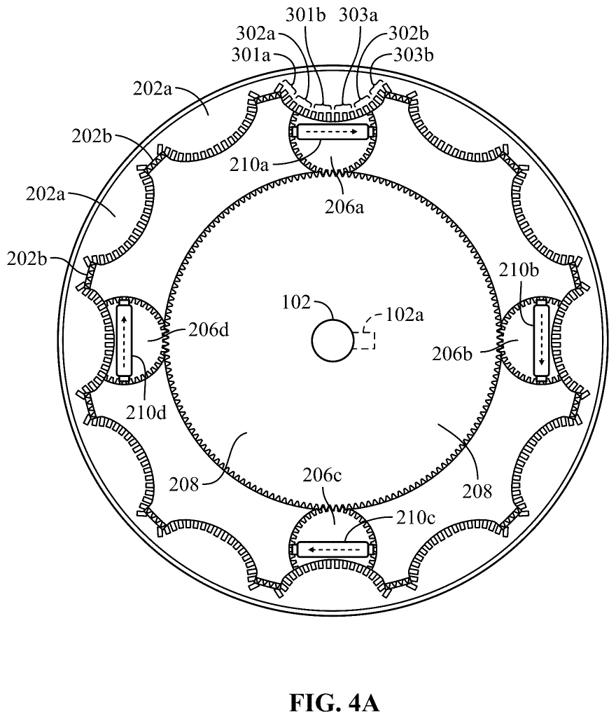

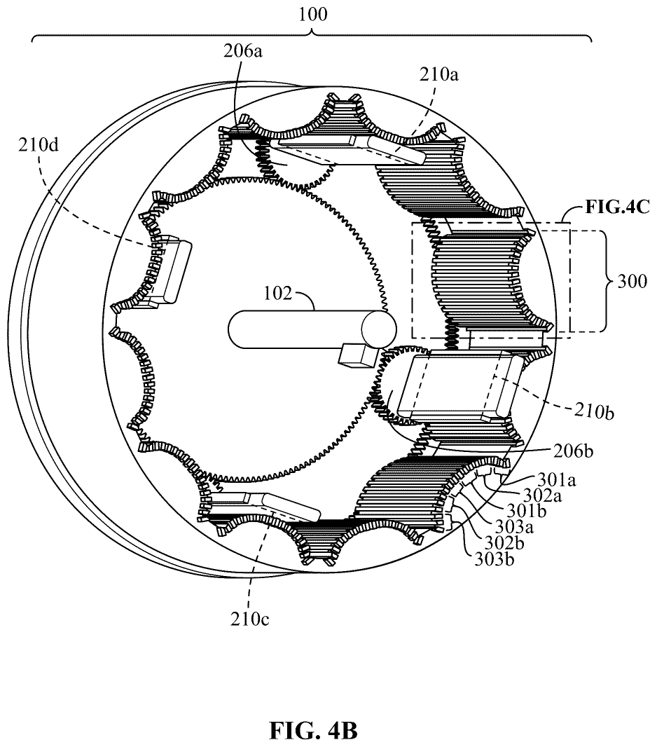

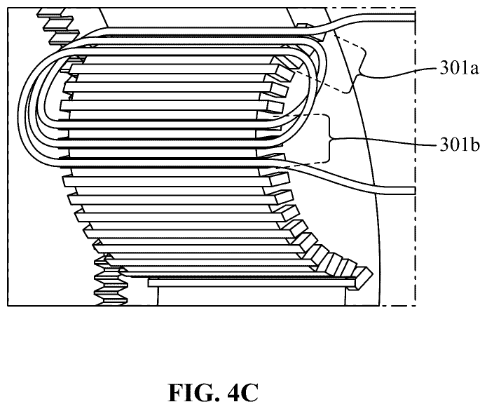

Each winding set 300 may have between one to 18 winding subsets 301a-303b (see FIG. 4A). In some examples, each winding set 300 may have greater than 18 winding subsets 301a-303b. As shown in FIG. 2B, the winding sets 300 may be spaced apart from each other by the stator body grooves 202b. The winding subsets 301-303 of each winding set 300 may have subset spacings 312 therebetween where the subset spacings 312 may extend along the length of the convex projections 202a having the winding subsets 301-303 mounted thereon.

By way of example and not limitation, the winding subsets 301-303 of adjacent winding sets 300 may share the same copper wiring. Similar to what is shown in FIG. 4C, the first winding subset 301 of a winding set 300 may be linked to the first winding subset 301 of an adjacent winding set 300 by using the same copper wire to create the coil loops. The second winding subset 302 and third winding subset 303 of the winding set 300 may have the same linkage to the adjacent winding set 300 as described with respect to the first winding subset 301. The aforementioned wiring linkage may apply to all of the winding sets 300 and winding subsets 301-303 of the stator 203.

In some examples, and as described with reference to FIG. 4C, two or more winding subsets 301a-b, 302a-b, 303a-b in the same winding set 300 may be linked together and share the same copper wiring. In the same winding set 300, there may be two or more winding subsets, such as 301a-b, that are electrically linked together and share the same copper wiring that is looped and winded together to make the coil winding subset. By way of example and not limitation, all of the winding subsets 301-303 in a winding set 300 may be electrically linked and connected together and share the same copper wiring that is looped and winded together to make the coil winding subset.

As described elsewhere herein, the winding sets 300 and subsets 301-303 may create magnetic fields when electric current is run through them for such magnetic fields to interact with the permanent magnets 210a-d attached to the planet gears 206a-d to provide magnetic forces to rotate the planetary rotor systems 201a-b and the output shaft 102, in general. Depending on which direction the current is traveling through the winding subsets 301-303, such subsets may create a magnetic field that creates an attractive or repulsive force with the poles of the permanent magnets 210a-d. Such attractive and repulsive forces may rotate the planet gears 206a-d that in turn rotate the sun gear 208 and the output shaft 102, as described elsewhere herein.

Referring back to FIG. 2A, the stator 202 and the stator body 203 may be between two planetary rotor systems 201a-b. One planetary rotor system 201a may be proximate to a first cylindrical end of the stator body 202 and a second planetary rotor system 201b may be proximate to a second cylindrical end of the stator body 202. The two planetary rotor systems 201a-b may be similar or the same, as described elsewhere herein. The planet gears 206a-d of the two planetary rotor systems 201a-b may be coupled and connected with each other via the permanent magnets 210a-d (see FIG. 2B) that extend through the inner cavity 205 of the stator body 202. The sun gears 208 of the two planetary rotor systems 201a-b may be coupled and connected with each other via the output shaft 102 (see FIG. 2A) that extend through the inner cavity 205 of the stator body 202. In another example, the planetary magnetic motor 100 may have one planetary rotor system 201a instead of two.

The center gear of the planetary rotor system 201a may have a sun gear 208 that is rotatable. The output shaft 102 may traverse through the center of the sun gear 208 and be affixed thereto. Consequently, the output shaft 102 may rotate at the same direction and revolutions per minute (RPM) as the sun gear 208. The shaft key 102a of the output shaft 102 may stick out from a surface of the sun gear 208 that is opposite to the inner cavity 205 of the stator body 202. As such, the shaft key 102a may stick out of the endcap 106 (see FIG. 1) and be configured to engage with a mechanical device or system requiring rotational force and torque. The sun gear 208 may have a diameter that is between ½ to sixteen times the diameter of each planet gear 206a-d. In some examples, the sun gear 208 may have a diameter greater than sixteen times the diameter of each planet gear 206a-d. The sun gear 208 of the planetary rotor system 201a may have spur, helical or bevel gear teeth.

The sun gear 208 may be coupled to a plurality of planet gears 206a-d where the gear teeth of the planet gears 206a-d may engage the gear teeth of the sun gear 208. Consequently, the gear teeth of the planet gears 206a-d may have corresponding shapes to the gear teeth of the sun gear 208 and be spur, helical, or bevel. The planet gears 206a-d may be positioned around the cylindrical ends of the stator body 202. The planet gears 206a-d may have a portion of their surface areas facing and overlapping with the stator 203, specifically the winding sets 300 and subsets 301-303 that are on the convex projections 202a (see FIGS. 3A-E). Such overlapping may allow for the permanent magnets 210a-d attached to the planet gears 206a-d and extending through the inner cavity 205 to be close to the winding sets 300 and experience the necessary magnetic forces to rotate the planet gears 206a-d around the sun gear 208. There may be between three to 12 planet gears 206a-d coupled around the sun gear 208. In some examples, there may be greater than 12 planet gears 206a-d coupled around the sun gear 208.

The planet gears 206a-d may be symmetrically spaced apart along the circumference of the sun gear 208 and ring gear 204. To find the relative symmetric angular position of the planet gears 206a-d between each other around the sun gear 208, 360-degrees may be divided by the number of the planet gears 206a-d to find out by how much angular displacement around the circular sun gear 208 the planet gears 206a-d are spaced apart from each other. By way of example and not limitation, the planet gears 206a-d may be symmetrically spaced apart from each other by 90-degrees along the sun gear 208 if there are four planet gears 206a-d. In other examples, the planet gears 206a-d may be asymmetrically spaced from each other along the circumference of the sun gear 208 and ring gear 204.

The planet gears 206a-d may also be coupled to a ring gear 204 defining the outer circular boundary of the planetary rotor system 201a and positioned around the outer boundary of the body 202 of the stator 203. The gear teeth of the planet gears 206a-d that face away from the sun gear 208 and are on the outer arclength of the planet gears 206a-d may be coupled and engage the inner gear teeth of the ring gear 204. Consequently, the inner gear teeth of the ring gear 204 may be correspondingly spur, helical, or bevel. The ring gear 204 may have an inner diameter and circular spacing within its ring body that may be 1.25 to three times the diameter of the sun gear 208. The ring gear 204 may also have internal gear teeth to couple and engage the circular planet gears 206a-d. The ring gear 204 may be stationary while the planet gears 206a-d and sun gear 208 rotate. In other embodiments, the ring gear may rotate, and the sun gear may stay stationary, as described elsewhere herein.

The first and second planetary rotor systems 201a-b may have the same gear setup, as described elsewhere herein. There may also exist spacing between the stator 203 and each of the planetary rotor system 201a-b, specifically with the ring gear and planet gears and the stator body 202. The spacing may be needed to reduce friction when the planet gears 206a-d are rotating and revolving around the sun gear 208 so that planet gears 206a-d are not contacting parts of the stator body 202, such as the convex projections 202a.

The planet gears 206a-d may rotate about their centers and revolve around the sun gear 208 that also correspondingly rotates about its center while the ring gear 204 remains stationary. The planet gears 206a-d may rotate and revolve around the sun gear 208 when the permanent magnets 210a-d (see FIG. 2B) attached to the planet gears 206a-d experience magnetic forces created by the magnetic field generated by the stator 203, as described elsewhere herein. The rotation and revolving of the planet gears 206a-d may in turn rotate the sun gear 208 and the output shaft 102 attached to the center of the sun gear 208. The sun gear 208 may rotate about its center in the opposite rotational direction of the planet gears 206a-d rotating about their centers and in the same translational revolving direction of the planet gears 206a-d, as described elsewhere herein. By way of example and not limitation, the sun gear 208 may rotate clockwise while the planet gears 206a-d rotate about their centers in the counterclockwise direction. Additionally, and in the same examples, the planet gears 206a-d may move and revolve around the sun gear 208 in a clockwise orientation that is in the same rotational direction of the sun gear 208 and output shaft 102. The reverse rotational direction may also be true where the planet gears 206a-d rotate clockwise about their center and move and revolve around the sun gear 208 in the counterclockwise direction while the sun gear 208 also spins about its center in the counterclockwise direction. The ring gear 204 may remain stationary while the planet gears 206a-d and sun gear 208 are rotating. In other embodiments, the ring gear may rotate and the sun gear may remain stationary, as described elsewhere herein.

The planet gears 206a-d may be rotated by the magnetic forces experienced by the permanent magnets 210a-d that are attached to the planet gears 206a-d, where the magnetic forces may be generated by the magnetic field created by the winding sets 300 of the stator 203. Each permanent magnet 210a-d may be rectangular shaped and have longitudinal sides and lateral sides. Each permanent magnet 210a-d may extend longitudinally through the length of the inner cavity 205 of the stator body 202 and have one lateral end attached to a planet gear 206a-d of the first planetary rotor system 201a and have a second lateral end attached to a corresponding and opposing planet gear 206a-d of the second planetary rotor system 201b that is aligned with the planet gear 206a-d of the first planetary rotor system 201a. In other words, each permanent magnet 210a-d may extend through the inner cavity 205 of the stator body 202 and be attached and sandwiched between two planet gears 206a-d of the opposing planetary rotor system 201a-d, which such two planet gears 206a-d align with each other on the opposing sides of the stator body 202. The lateral sides of the permanent magnets 210a-d may be attached along the diameters of the planet gears 206a-d, and the lateral sides of the permanent magnets 210a-d may have a width that is less than or equal to the diameter of the planet gears 206a-d. In some examples, the width of the lateral sides of the permanent magnets 210a-d may be greater than the diameter of the planet gears 206a-d. As shown in FIG. 3A, the first and second poles 304a-b of the permanent magnets 210a-d may be along the width of the magnets where the first pole 304a may be proximate to a first width end and the second pole 304b may be proximate to a second width end of the permanent magnets 210a-d. Consequently, both the first and second poles 304a-b of the permanent magnets 210a-d extend along the length of the magnets and the inner cavity 205 of the stator body 202 and face the full length of the winding subsets 301-303. Alternatively, each permanent magnet 210a-d may be cylindrical.

The permanent magnets 210a-d may be neodymium or ferrite magnets. The permanent magnets 210a-d may have a casing layer 212 covering them that may allow for ease of coupling with the planet gears 206a-d. The casing layer 212 may also protect the permanent magnets 210a-d, especially if the magnets are ferrite magnets or brittle in general. The casing layer 212 may be made of a material and be thin such that the layer does not interfere with the magnetic field created by the permanent magnet 210a-d having the casing layer 212. It should be noted that the casing layer 212 may be optional and the planetary magnetic motor 100 may function without such layer.

Referring now to FIGS. 3A-E, the actuation of the planetary magnetic motor 100 is shown. FIGS. 3A-E may be a front view of the planetary magnetic motor 100 shown in FIG. 2B, but with the planet gears 206a-d symmetrically orientated around the sun gear 208 slightly differently. Consequently, the planet gears 206a-d and the sun gear 208 shown in FIGS. 3A-E may be part of the second planetary rotor system 201b.

The actuation and rotation of the output shaft 102 may be done using the planetary rotor systems 201a-b, described elsewhere herein, that rotate due to the magnetic interaction between the permanent magnets 210a-d, attached to the planet gears 206a-d, and the winding sets 300 having electric current in alternating directions ran through the windings. The electric current used to actuate the planetary magnetic motor 100 may be alternating current. The alternating current may be single-phase (see FIGS. 6A-B) generated by a single-phase electric power or multiphase current (see FIG. 6C) generated by multiphase electric power. The multiphase current may be a three-phase current derived from three-phase electric power. The generation of magnetic field by the winding sets 300 for creating the magnetic forces to rotate the gears in FIGS. 3A-E is shown using a single-phase alternating current. However, multiphase alternating currents, such as a three-phase alternating current shown in FIG. 6C, may also be used with the winding sets 300 to generate a magnetic field that rotates the planetary rotor systems 201a-b and the output shaft 102, in general.

The alternating current supplied to the winding sets 300 of the planetary magnetic motor 100 may have different wave forms. The alternating current may be sinusoidal (see FIG. 6A), square form (see FIG. 6B), or triangular form (not shown). Using a square wave form shown in FIG. 6B to drive current in the winding sets 300 may simplify the operation and actuation of the planetary magnetic motor 100 and provide consistent amount of current in both positive and negative direction. The same magnitude of current may be supplied in the negative and positive current directions 308, 310 using square wave form, as shown in FIG. 6B, and the direction of the current may be changed to reverse the magnetic field generated by the winding sets 300.

As shown in FIGS. 3A-E, the electric current in the winding subsets 301, 303 of the winding sets 300 may alternate between a negative current direction 308 and a positive current direction 310. Consequently, the magnetic field generated by the winding subsets 301, 303 may reverse and alternate. Such alternating in current direction 308, 310 and magnetic field may create the necessary attractive and repulsive forces 306a-b acting on the first and second poles 304a-b of the permanent magnets 210a-d to rotate the planet gears 206a-d and in turn the sun gear 208 and the output shaft 102.

The electric current directions 308, 310 may run along the length of the winding subsets 301, 303 as the electrons travel along the copper wiring of the windings. The negative current direction 308 may be an opposite direction to how the electrons travel along the length of the wiring of the winding subsets 301, 303 in the positive current direction 310. The negative current direction 308 in a winding subset 301, 303 may be a direction that creates a magnetic field that produces an attractive force 306a between the north pole 304a of the permanent magnet 210a-d and the winding subset 301, 303 and a repulsive force 306b between the south pole 304b of the permanent magnet 210a-d and the winding subset 301, 303. The positive current direction 310 in a winding subset 301, 303 may be a direction that creates a magnetic field that produces an attractive force 306a between the south pole 304b of the permanent magnet 210a-d and the winding subset 301, 303 and a repulsive force 306b between the north pole 304a of the permanent magnet 210a-d and the winding subset 301, 303.

By way of example and not limitation, the current directions 308, 310 in all of the winding sets 300 may be identically synchronized when operating the motor and rotating the planetary rotor systems 201a-b. As such, the current directions 308, 310 of the winding subsets 301, 303 making up the winding sets 300 may mirror the other winding sets 300 of the stator 203 of the motor. Although the current direction 308, 310 of the winding subsets 301,303 in a winding set 300 are shown to be the same direction, in some examples the winding subsets 301, 303 making up a winding set 300 may have a combination of negative direction current 308 and positive direction current 310 at the same time. Such alternate example may be true when using a three-phase electric power rather than single-phase electric power in operating and actuating the planetary magnetic motor 100.

In another example, different winding sets 300 of the stator 203 may have different current directions 308, 310 than the other winding sets 300 making up the stator 203. By way of example and not limitation, a winding set 300 may have all its winding subsets 301-303 in a negative current direction 308 while at the same time another winding set 300 may have all its winding subsets 301-303 in a positive current direction 310. The relative positioning between the aforementioned winding sets 300 may be adjacent, opposing, or every other winding set 300. The aforementioned example may be implemented when a multiphase power (e.g., three-phase electric power) is used to supply current to the stator 203 and the winding sets 300 of the planetary magnetic motor 100.

As shown in FIGS. 3A-E, all of the winding sets 300 may be activated and have electric current running through their winding subsets 301-303 when the planetary magnetic motor 100 is turned on to rotate the gears and the output shaft 102. All of the winding sets 300 being activated at all times during the operation of the motor may simplify the electrical designing of such device. In other examples, only the winding sets 300 that have permanent magnets 210a-d near and overlapping with their winding subsets 301-303 may have current running therethrough, and the other winding sets 300 may be turned off and have no electric current. Optionally, the activation of the winding sets 300 when a permanent magnet 210a-d is near and overlapping with their winding subsets 301-303 may be accomplished using a position encoder. The position encoder may be designed to track the positioning of each permanent magnet 210a-d relative to the position of the different winding sets 300 around the inner cavity 205 of the stator 203. When the position encoder detects that the permanent magnet 210a-d is facing and overlapping with a winding set 300, such winding set 300 may be activated to have electric current run therethrough. The other winding sets 300 that do not have a permanent magnet 210a-d near may be deactivated.

Alternatively, and optionally again, the position encoder may be designed to track the positioning of each planet gear 206a-d, having a permanent magnet 210a-d attached thereto, relative to the position of the different winding sets 300 around the inner cavity 205 of the stator 203. When the position encoder detects that the planet gear 206a-d is in the same angular position as a winding set 300 occupying an arclength of the cylindrical stator body 202, such winding set 300 may be activated to have electric current run therethrough. Alternatively, the encoder may track the magnetic fields of the permanent magnets 210a-d and turn on the winding sets 300 that are proximate to a threshold magnetic field sensed by the encoder, and the other winding sets 300 that do not have a permanent magnet 210a-d near may be deactivated. The other winding sets 300 that do not have a planet gear 206a-d near may be deactivated. The selective activation of the winding sets 300 as described herein may make the planetary magnetic motor 100 more energy efficient since the winding sets 300 not having a permanent magnet 210a-d nearby may be deactivated and not use electricity and energy.

As shown in FIGS. 3A-E, the first and third winding subsets 301, 303 in a winding set 300 may have the same current direction 308, 310, and the second winding subset 302 may be disabled, used for startup purposes, or contain an intermingling of additional windings connected to both 301 and 302. This may be the case if a single-phase electric power having a single-phase alternating current is used. In other examples, where a multiple-phase electric power (e.g., three-phase electric power) is used to power the planetary magnetic motor 100, the winding subsets 301-303 in a winding set 303 may have different current directions 308, 310 where some of the subsets run in the negative current direction 308 and the other winding subsets run in the positive current direction 310. The second winding subset 302 may be activated when a three-phase electric power is applied to the planetary magnetic motor 100. In other examples, one or more winding subset 301-303 in a winding set 300 may be deactivated while the other winding subsets 301-303 are activated and having a current running therethrough.

As shown in FIGS. 3A-E the output shaft 102 may rotate as current is alternated in the winding sets 300 that provide the necessary magnetic forces 306a-b to rotate the planet gears 206a-d and sun gear 208 using the permanent magnets 210a-d. The permanent magnets 210a-d may be attached to the planet gears 206a-d, as described elsewhere herein. The magnetic force 306a-b that the permanent magnets 210a-d experience from the magnetic field of the winding sets 300 may translate to rotational force on the planet gears 206a-d. Such rotational force may be translated to the sun gear 208 that is coupled to the planet gears 206a-d. The direction of the rotation of the gears in the planetary rotor system may be reversed by reversing the sequence direction of the alternating current, or reversing the orientation of the positioning of the poles 304a-b of the permanent magnets 210a-d on the planet gears 206a-d.

The output shaft 102 may rotate in the same direction as the sun gear 208, as shown by the rotation of the shaft key 102a in FIGS. 3A-E. The sun gear 208 may rotate about its center in the opposite direction as to the rotation direction of the planet gears 206a-d about their centers. By way of example and not limitation, the sun gear 208 may rotate clockwise about its center as the planet gears 206a-d rotate counterclockwise about their centers. As the planet gears 206a-d rotate about their centers, such gears may also move and revolve around the sun gear 208, as shown in FIGS. 3A-E. The planet gears 206a-d may revolve around the sun gear 208 in the same direction that the sun gear 208 rotates about its center. By way of example and not limitation, the planet gears 206a-d may move and revolve around the sun gear 208 in a clockwise direction (see FIGS. 3A-E) as the sun gear 208 rotates about its center in the clockwise direction. Alternatively, the planet gears 206a-d may revolve counterclockwise around the sun gear 208 as the sun gear 208 rotates counterclockwise about its center. The planet gears 206a-d may also revolve around the sun gear 208 in the opposite direction that the planet gears 206a-d rotate about their centers. By way of example and not limitation, the planet gears 206a-d may move and revolve around the sun gear 208 in a clockwise direction as such planet gears rotate about their centers in the counterclockwise direction. Alternatively, the planet gears 206a-d may revolve counterclockwise around the sun gear 208 as such gears rotate about their center in the clockwise direction.

The lateral sides of the permanent magnets 210a-d may be attached along the diameters of the planet gears 206a-d. As shown in FIG. 3A, the first and second poles 304a-b of the permanent magnets 210a-d may be along the width of the magnets where the first pole 304a may be proximate to a first width end and the second pole 304b may be proximate to a second width end of the permanent magnets 210a-d. Consequently, the first pole 304a of the permanent magnets 210a-d may be proximate to a first diameter end of the planet gears 206a-d, and the second pole 304b of the permanent magnets 210a-d may be proximate to a second diameter end that opposes the first diameter end of the planet gears 206a-d. This may be because the lateral sides of the permanent magnets 210a-d are attached along the diameters of the planet gears 206a-d. Both the first and second poles 304a-b of the permanent magnets 210a-d may also extend along the length of the magnets and the inner cavity 205 of the stator body 202 and face the full length of the winding subsets 301-303. As such, the magnetic fields generated by the winding subsets 301-303 may act upon the poles 304a-b of the permanent magnets 210a-d to provide attractive and repulsive forces 306a-b that rotate the planet gears 206a-d coupled to such magnets. Such rotational motion may be transmitted to the sun gear 208 in the center of the planet gears 206a-d.

As described elsewhere herein, the planet gears 206a-d in the first planetary rotor system 201a (see FIG. 2A) may align and pair with the planet gears 206a-d in the second planetary rotor system 201b. As described elsewhere herein, a permanent magnet 210a-d may be coupled in between each pair of planet gears 206a-d and extend through the inner cavity 205 of the stator 203. Consequently, the permanent magnets 210a-d may be symmetrically spaced apart from each other along the circular circumference of the stator body 202, and in its inner cavity 205, as the planet gears 206a-d are symmetrically spaced apart from each other, as described elsewhere herein. The angle of symmetry between the permanent magnets along the circumference of the stator body 202 and its inner cavity 205 may be determined by dividing 360-degrees by the number of permanent magnets 210a-d. By way of example and not limitation, if the planetary magnetic motor 100 has four permanent magnets 210a-d attached between the planetary rotor systems 201a-d, and inside the inner cavity 205 of the stator body 202, then those four permanent magnets 210a-d may be symmetrically spaced apart from each other along the circumference of the stator body 202 by 90-degrees. The symmetry of the permanent magnets 210a-d may allow for ease of calibration for when the current directions 308, 310 (see FIGS. 3A-E) in the winding sets 300 and winding subsets 301-303 should be negative and positive to actuate the motor. In other examples, the permanent magnets 210a-d may be asymmetrically spaced apart from each other. Consequently, the planet gears 206a-d may also be asymmetrically spaced apart from each other in such other examples.

The magnetic poles 304a-b of the permanent magnets 210a-d may also be symmetric to the other permanent magnets 210a-d around the sun gear 208 and inside the inner cavity 205 of the stator body 202. By way of example and not limitation, when going one clockwise revolution around the sun gear 208 in FIG. 3A, all of the permanent magnets 210a-d may have their first pole 304a (e.g., north pole) as the leading pole and the second pole 304b (e.g., south pole) as the trailing pole. The leading pole of the permanent magnet 210a-d may be defined as the pole that is farthest in the clockwise position, when moving in the clockwise orientation, and the trailing pole may be defined as the pole that is nearest in the clockwise position. In a similar example, the second pole 304b may be the leading pole and the first pole 304a may be the trailing pole when moving one clockwise revolution around the sun gear 208 and when the poles of the permanent magnets 210a-d are symmetric to each other. Moving along the counterclockwise revolution around the sun gear 208 may also have the similar pole symmetry between the permanent magnets 210a-d, as described with the clockwise revolution. Such symmetry of magnetic poles 304a-b between the permanent magnets 210a-d may allow for ease of calibration for when the current directions 308, 310 (see FIGS. 3A-E) in the winding sets 300 and winding subsets 301-303 should be negative and positive to actuate the motor.

The actuation and rotation of the planetary magnetic motor 100 at different intervals of time will now be analyzed with respect to FIGS. 3A-E. FIGS. 3A-E may show the planet gears 206a-d revolving around the sun gear 208 by a quarter of a revolution, which may rotate the output shaft 102 and the sun gear 208 by more than half of revolution. In some examples, depending on the relative size of the planet gears 206a-d to the sun gear 208, the output shaft 102 and sun gear 208 may rotate a full revolution when the planet gears 206a-d revolve around the sun gear 208 by a quarter of a revolution. In FIGS. 3A-E, a single-phase current is run through the winding subsets 301, 303 of the winding sets 300. Specifically, the first and third winding subsets 301, 303 may have current running therethrough, and the second winding subset 302 may be disabled, used for startup purposes, or contain an intermingling of additional windings connected to both 301 and 303. Alternatively, the winding sets 300 and winding subsets 301-303 may all have the same current direction that is either negative 308 or positive 310. The current directions in each of FIGS. 3A-E may be tracked on the alternating current graphs shown in FIG. 6A or FIG. 6B. The difference between the current graph of FIGS. 6A and 6B is that FIG. 6A is a sinusoidal wave form and FIG. 6B is a square wave form, which the advantages and disadvantages of the different types of wave forms are described elsewhere herein. Nonetheless, the current may need to change between the negative direction 308 and the positive direction 310 to create alternating magnetic fields that create the correct attractive and repulsive force 306a-b relative to the positioning of the north and south poles 304a-b with respect to the winding subsets 301-303. The usage of a three-phase current (see FIG. 6C) is also contemplated herein where different winding sets 300 around the inner cavity 205 of the stator body 202 are electrically connected to one of the three phases of current. In another example, different winding subsets 301-303 may be electrically connected to one of the three phases of current shown in FIG. 6C.

In general, to rotate the planet gears 206a-d counterclockwise and revolve them around the sun gear 208 in a clockwise direction, the leading magnetic pole of the permanent magnets 210a-d (i.e., the magnetic pole that is farthest and leading in a clockwise direction) may need an attractive force 306a pulling such poles towards a leading winding subset 303 having electric current, and the trailing magnetic pole (i.e., the magnetic pole that is trailing behind the leading pole in the clockwise direction) may need a repulsive force 306b pushing the trailing poles away from trailing winding subset 301. The reverse may also be true, where to rotate the planet gears 206a-d clockwise and revolve them around the sun gear 208 in a counterclockwise direction, the leading magnetic pole of the permanent magnets 210a-d (i.e., the magnetic pole that is farthest and leading in a counterclockwise direction) may need an attractive force 306a pulling such poles towards a leading winding subset 301 having electric current, and the trailing magnetic pole (i.e., the magnetic pole that is trailing behind in the counterclockwise direction) may need a repulsive force 306b pushing the trailing poles away from trailing winding subset 303. Such attractive and repulsive force 306a-b may be created by the magnetic field of the current that is run through the winding subsets 301-303, which the direction of the current 308, 310 and the magnetic field may be calibrated and be based on where the north and south poles 304a-b of the permanent magnets 210a-d are located relative to the trailing, middle, and leading winding subsets 301-303.

Referring specifically to FIGS. 3A-B, the planet gears 206a-d are shown as revolving incrementally clockwise around the sun gear 208. As the planet gears 206a-d move clockwise around the sun gear 208, such gears rotate about their centers in the counterclockwise orientation. Such counterclockwise rotation may rotate the sun gear 208 and the output shaft 102 clockwise. Although the ring gear 204 is not shown (see FIG. 2A), the ring gear 204 may be fixed in place and remain stationary to provide the support structure that allows the planet gears 206a-d to rotate about their centers and revolve around the sun gear 208 to rotate and actuate the sun gears 208 and output shaft 102. The planet gears 206a-d may have a portion of their planar surface areas facing and overlapping with the stator 203, specifically the winding sets 300 and subsets 301-303 that are on the convex projections 202a. Such overlapping may allow for the permanent magnets 210a-d attached to the planet gears 206a-d, and extending through the inner cavity 205 of the stator body 202, to be close to the winding sets 300, and their subsets 301-303, to experience the necessary magnetic forces to rotate the planet gears 206a-d around the sun gear 208.

As shown in FIG. 3A, when moving clockwise around the sun gear 208, the north poles 304a of the permanent magnets 206a-d may be the leading pole (i.e., the magnetic pole that is leading and farthest in a clockwise direction) and the south poles 304b may be the trailing pole (i.e., the magnetic pole that is trailing behind the leading pole in the clockwise direction). Alternatively, the leading and trailing orientation of the north and south poles 304a-b may be reversed. To rotate each planet gear 206a-d counterclockwise around their centers and move them clockwise around the sun gear 208, an attractive force 306a may be generated by the third winding subset 303, which may be the subset that is leading and farthest in the winding set 300 in the clockwise direction, which pulls the first poles 304a (e.g., north pole) of the permanent magnets 210a-d towards the third winding subset 303. Additionally, a repulsive force 306b may be generated by the first winding subset 301, which may be the subset that is trailing behind in the clockwise direction in the winding set 300 and farthest in the counterclockwise orientation, that pushes the second pole 304b (e.g., south pole) of the permanent magnets 210a-d away from the first winding subset 301. Consequently, the generated attractive forces 306a may pull the permanent magnets 210a-d and the planet gears 206a-d in the counterclockwise direction, and the generated repulsive forces 306b may push away the permanent magnets 210a-d and the planet gears 206a-d in the counterclockwise direction. The second winding subset 302 may be disabled and not have current run therethrough. To reverse the rotational motion and rotate each planet gear 206a-d clockwise around their centers and move them counterclockwise around the sun gear 208, the described attractive and repulsive forces 306a-b may be reversed. An attractive force 306a may be generated by the third winding subsets 303 that pulls the second poles 304b (e.g., south pole) of the permanent magnets 210a-d towards the third winding subset 303. A repulsive force 306b may be generated by the first winding subset 301 that pushes the first pole 304a (e.g., north pole) of the permanent magnets 210a-d away from the first winding subset 301.

The attractive and repulsive forces 306a-b on the permanent magnets 210a-d shown in FIG. 3A that move the planet gears 206a-d in the clockwise position around the sun gear 208, shown in FIG. 3B, may be generated by magnetic fields between the permanent magnets 210a-d and the winding subsets 301, 303 of the winding sets 300. The winding subsets 301, 303 may have electric current run through them in a specific direction along the wiring of the subsets to generate the required magnetic field that creates the attractive and repulsive forces 306a-b moving the planet gears 206a-d from their positions in FIG. 3A to their positions in FIG. 3B. As shown in FIG. 3A, the electric current may be run in a negative direction 308 that creates a magnetic field, where the winding subsets 301, 303 change to have magnetic field lines of south poles proximate to the north and south poles 304a-b of the permanent magnets 210a-d, to rotate the planet gears 206a-d counterclockwise and move them clockwise around the sun gear 208. The electric current running in the negative current direction 308 along the first winding subset 301 may create magnetic field lines resembling a south pole of a magnet that is proximate and closest to the trailing south pole 306b of the permanent magnet 210a-d shown in FIG. 3A. Consequently, the repulsive force 306b may be created therebetween. Similarly, the electric current running in the negative current direction 308 along the third winding subset 303 may create magnetic field lines resembling a south pole of a magnet that is proximate and closest to the leading north pole 306a of the permanent magnet 210a-d. Consequently, an attractive force 306a may be created therebetween. The middle winding subsets 302 may be disabled.

Referring now to FIGS. 3B-C, the planet gears 206a-d are shown revolving further clockwise around the sun gear 208. As the planet gears 206a-d rotate counterclockwise about their center between FIGS. 3A-B, the orientation of the magnetic poles 304a-b of the permanent magnets 210a-d may change. As shown in FIG. 3B, the second pole 304b (e.g., south pole) may now be the leading pole and farthest in the clockwise direction and the first pole 304a (e.g., north pole) may be the trailing pole behind the second pole 304b in the clockwise direction. Since the relative positioning of the magnetic poles 304a-b of the permanent magnets 210a-d are switched, the current in the winding subsets 301-303 may switch to the positive direction 310 to create the necessary attractive and repulsive forces 306a-b on the magnets for the planet gears 206a-d to continue rotating and revolving. As shown in FIG. 3B, the electric current may run in a positive direction 310 that creates a magnetic field, where the winding subsets 301, 303 change to have magnetic field lines of north poles proximate to the north and south poles 304a-b of the permanent magnets 210a-d, to rotate the planet gears 206a-d counterclockwise and move them clockwise around the sun gear 208. The electric current running in the positive current direction 310 along the first winding subset 301 may create magnetic field lines resembling a north pole of a magnet that is proximate and closest to the trailing north pole 304a of the permanent magnet 210a-d shown in FIG. 3B. Consequently, the repulsive force 306b may be created therebetween. Similarly, the electric current running in the positive current direction 310 along the third winding subset 303 may create magnetic field lines resembling a north pole of a magnet that is proximate and closest to the leading south pole 304b of the permanent magnet 210a-d. Consequently, an attractive force 306a may be created therebetween. The middle winding subsets 302 may be disabled. Such forces may transition the positioning of the planet gears 206a-d from FIG. 3B to FIG. 3C.

The rotation of the planet gears 206a-d in FIGS. 3C-E may follow the same physics and description as described with respect to FIGS. 3A-C, depending on which magnetic pole 304a-b is leading and trailing. Additionally, the sequence of the current direction in the winding subsets 301, 303 with respect to FIGS. 3A-E may be tracked on the current graphs of FIGS. 6A-B. In some examples, the current in the winding subsets 301, 303 may have a value of zero (i.e., between the transitioning of negative and positive current 308, 310) when the permanent magnets 210a-d are between two winding sets 300 and within the stator body grooves 202b. At such position, the lateral sides of the permanent magnets 210a-d may also be perpendicular to the stator body grooves 202b. As described elsewhere herein, a three-phase current (see FIG. 6C) may alternatively be used to provide current to the winding sets 300, where different winding sets 300 may be wired to different current phases. Alternatively, different winding subsets 301-303 may be wired to different current phases of the three-phase current.

The described rotation of the planet magnets 206a-d and their revolving around the sun gear 208, either in the clockwise or counterclockwise, may in turn rotate the sun gear 208 of each planetary rotor system 201a-b and the output shaft 102 in the center of the sun gears 208. The output shaft 102 of the of the planetary magnetic motor 100 may rotate between up to 24,000 RPM either clockwise or counterclockwise, based on the described actuation of the planetary rotor systems 201a-b.

Referring now to FIG. 4A, another example of the planetary magnetic motor 100 is shown where the winding sets 300 have additional winding subsets 301a-b, 302a-b, 303a-b when compared to FIGS. 3A-E. The additional winding subsets 301a-b, 302a-b, 303a-b may smoothen, fasten, and better the rotation of the planet gears 206a-d, as described elsewhere herein. This may be because the additional winding subsets 301a-b, 302a-b, 303a-b may create additional magnetic fields that combine to impose more attractive and repulsive forces on the magnetic poles 304a-b of the permanent magnets 210a-b attached to the planet magnets 206a-b to rotate the gear system and the output shaft 102. The additional winding subsets 301a-b, 302a-b, 303a-b may be electrically connected to a single-phase current or a multi-phase current (e.g., three-phase current), as described elsewhere herein.

As shown in FIG. 4A, each winding set 300 may have six winding subsets 301a-b, 302a-b, 303a-b. In other examples, each winding subset 300 may have between one to 18 winding subsets 301a-b, 302a-b, 303a-b. In other examples, each winding subset 300 may have greater than 18 winding subsets 301a-b, 302a-b, 303a-b. The greater the amount of winding subsets 301a-b, 302a-b, 303a-b, the planet gears 206a-d may rotate smoother, faster, and better. As shown in FIG. 4A, each winding subset 301a-b, 302a-b, 303a-b may have three modules of wiring coils. In other examples, each winding subset 301a-b, 302a-b, 303a-b may have greater than three modules of wiring coils.

The winding subsets 301a-b, 302a-b, 303a-b may be distributed along the curvature of the convex projections. The winding subsets 301a-b, 302a-b, 303a-b may be distributed in a way that a winding subset 301a may share the same wiring, which creates the wiring coils of the subset, with the winding subset 301b that is one after the adjacent winding subset 302a. Consequently, in the example of FIG. 4A, adjacent winding subsets 301a-b, 302a-b, 303a-b may not share the same wiring in forming their modules of wiring coils. Alternatively, all the winding subsets 301a-b, 302a-b, 303a-b may share the same wiring in creating winding coils, as described elsewhere herein. In other examples, winding subsets may be intermingled into adjacent winding subsets to improve performance characteristics. By way of example and not limitation, winding subset 301a of FIG. 4A may have some of its wire windings mixed in with winding subset 302a, and winding subset 302a may have wire windings mixed in with winding subset 301a. This intermingling may occur with all winding sets 301a-b, 302a-b, and 303a-b of FIG. 4A. In other examples, the layout of winding subsets 301a-b, 302a-b, and 303a-b may be in a different order than shown in FIG. 4A.

By way of example and not limitation, a three-phase current (see FIG. 6C) may be used with the planetary magnetic motor 100 of FIG. 4A where each corresponding winding subsets (i.e., 301a with 301b, 302a with 302b, 303a with 303b) may be electrically connected to one of three-phases of the current that are different from the other two. The current direction of corresponding winding subsets (i.e., 301a with 301b, 302a with 302b, 303a with 303b) may be reversed since the same wiring that is used to create the corresponding winding subsets may be looped, which such loops reverse the current direction in the corresponding winding subsets. Alternatively, a single-phase current may be used in all of the winding subsets 301a-b, 302a-b, 303a-b. In the alternative example, all of the winding subsets 301a-b, 302a-b, 303a-b may have the same current direction, as described elsewhere herein, or the current direction of corresponding winding subsets (i.e., 301a with 301b, 302a with 302b, 303a with 303b) may be reversed, as described elsewhere herein. Consequently, the additional winding subsets 301a-b, 302a-b, 303a-b shown in FIG. 4A may allow for more electrical configurations in operating the planetary magnetic motor 100, whether using multi-phase current or single-phase current.

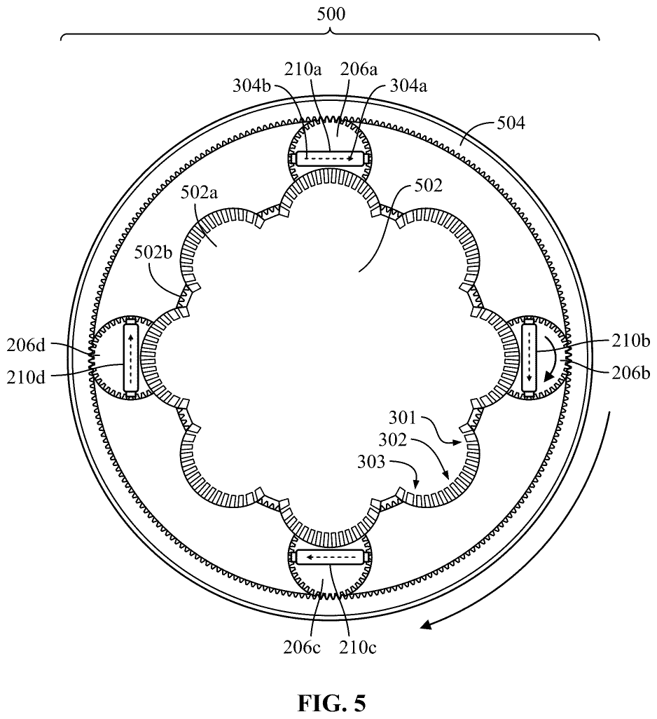

Referring now to FIG. 5, another embodiment of the planetary magnetic motor 500 is shown. The embodiment of the planetary magnetic motor 500 of FIG. 5 may have similar features as described elsewhere herein with respect to the primary embodiment of the planetary magnetic motor 100. The difference in this embodiment may be that the planet gear 208 may be replaced by a stationary winding planet 502 and the ring gear 504 may be the rotating structure corresponding to the rotation of the planet gears 206a-d. The rotating ring gear 504 may be the rotatable output structure that substitutes the rotatable output shaft 102 of the primary embodiment.

The planet gears 206a-d may have permanent magnets 210a-d attached thereto that magnetically interact with the winding sets 300 and winding subsets 301-303 to rotate the planet gears 206a-d, as described elsewhere herein. To move the rotating ring gear 504 clockwise, the planet gears 206a-d may need to rotate about their centers in the clockwise direction and revolve around the stationary winding planet 502 also in the clockwise direction. To move the rotating ring gear 502 counterclockwise, the planet gears 206a-d may need to rotate about their centers in the counterclockwise direction and revolve around the stationary winding planet 502 also in the counterclockwise direction.

The stationary winding planet 502 that is in the center of the planetary magnetic motor 500 may have the winding sets 300 and subsets 301-303 distributed around the outer boundaries of the stationary planet body. The planet body of the stationary winding planet 502 may have convex projections 502a that have the winding subsets 301-303 distributed around the outer convex curvature, as described elsewhere herein. The planet body of the stationary winding planet 502 may have body grooves 502b between the convex projections 502a and the winding sets 300, as described elsewhere herein. The winding sets 300 of the stationary winding planet 502 may be the same and create similar magnetic fields and forces with the magnetic poles 304a-b of the permanent magnets 210a-d, as described elsewhere herein.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of actuation of a planetary magnetic motor, comprising:
providing a stator having a chamber with a plurality of winding sets distributed around an inner surface of the chamber;
providing a planetary rotor system having a central sun gear with an output shaft, a plurality of planet gears coupled around the central sun gear, and a ring gear defining an outer boundary of the planetary rotor system and coupled to the plurality of planet gears;
providing a plurality of permanent magnets wherein each permanent magnet has a first magnetic pole and a second magnetic pole and is attached to a planet gear of the plurality of planet gears, the plurality of permanent magnets inside the chamber of the stator and proximate to the winding sets, the first magnetic poles of the plurality of permanent magnets leading in position relative to the second magnetic poles of the plurality of permanent magnets along a revolving path of the plurality of planet gears around the central sun gear;
running an electric current in a first direction in the plurality of winding sets such that a first magnetic field is produced that delivers an attractive force to the first magnetic poles of the plurality of permanent magnets and a repulsive force to the second magnetic poles such that the plurality of planets gears are rotated that in turn causes the central sun gear to also rotate and the planet gears to revolve around the central sun gear, a rotation of the plurality of planet gears changing positions of the first magnetic poles relative to the second magnetic poles of the plurality of permanent magnets such that the second magnetic poles are leading in position along the revolving path of the plurality of planet gears and the first magnetic poles are trailing in position; and
running the electric current in a second direction in the plurality of winding sets such that a second magnetic field is produced that delivers an attractive force to the second magnetic poles of the plurality of permanent magnets and a repulsive force to the first magnetic poles such that the plurality of planets gears are further rotated that causes the central sun gear to also in turn further rotate and the planet gears to further revolve around the central sun gear.

2. The method of claim 1, wherein the plurality of planet gears revolve around the central sun gear in a same direction as the central sun gear rotates.

3. The method of claim 1, wherein the ring gear remains stationary during actuation of the planetary magnetic motor.

4. The method of claim 1, wherein the chamber of the stator has a plurality of convex projections along an outer boundary of the chamber and each winding set occupies a convex projection of the plurality of convex projects.

5. The method of claim 1, wherein the plurality of winding sets each comprise a plurality of winding subsets that are spaced apart from each other.

6. The method of claim 1, wherein the electric current has an alternating square wave form.

7. The method of claim 1, where the electric current has an alternating sinusoidal wave form.

8. A planetary magnetic motor, comprising:
a stator having a stator body with a first open end opening to a central cavity that extends along a length of the stator body, the central cavity having an outer boundary and a center within the stator body;
a plurality of winding sets distributed around the outer boundary of the central cavity of the stator body, the plurality of winding sets configured to receive alternating electric current and produce alternating magnetic fields;
a planetary rotor system proximate to the first open end of the stator body, the planetary rotor system comprising:
a sun gear being central of the planetary rotor system by positioned proximate to the center of the central cavity;
a plurality of planet gears coupled around the sun gear and facing the plurality of winding sets of the stator;
a ring gear coupled to the plurality of the planet gears, the ring gear defining an outer boundary of the planetary rotor system;
an output shaft attached in the middle of the sun gear; and
a plurality of permanent magnets, each permanent magnet extending inside the central cavity of the stator body and having a lateral side attached to one of the plurality of planet gears, and each permanent magnet having a first magnetic pole proximate to a first width end of the permanent magnet and a second magnetic pole proximate to a second width end of the permanent magnet, the first and second magnetic poles of each permanent magnet being proximate to the plurality of winding sets and configured to experience magnetic forces from the alternating magnetic fields that the winding sets are configured to generate and to rotate the planetary rotor system.

9. The planetary magnetic motor of claim 8, wherein the stator body has a plurality of convex projections along the outer boundary of the central cavity and each winding set occupies a convex projection of the plurality of convex projects.

10. The planetary magnetic motor of claim 9, wherein the plurality of winding sets each comprise a plurality of winding subsets that are spaced apart from each other.

11. The planetary magnetic motor of claim 8, wherein the planetary rotor system is a first planetary rotor system and the planetary magnetic motor further comprises a second planetary rotor system proximate to a second open end of the stator body opening to the central cavity.

12. The planetary magnetic motor of claim 11, wherein the output shaft of the first planetary rotor system extends within the central cavity and the length of the stator body and is attached to a sun gear of the second planetary rotor system.

13. The planetary magnetic motor of claim 8, wherein the alternating electric current that the plurality of winding sets are configured to receive is a three-phase alternating current.

14. The planetary magnetic motor of claim 8, wherein the plurality of planet gears include four planet gears symmetrically spaced apart from each other around the sun gear.

15. The planetary magnetic motor of claim 8, wherein the magnetic forces that the first and second magnetic poles of each permanent magnet are configured to experience from the alternating magnetic fields include both an attractive force and a repulsive force.

16. A method of actuation of a planetary magnetic motor, comprising:
providing a stator having a chamber with a plurality of winding sets distributed around an inner surface of the chamber;
providing a planetary rotor system having a central sun gear with an output shaft, a plurality of planet gears coupled around the central sun gear, and a ring gear defining an outer boundary of the planetary rotor system and coupled to the plurality of planet gears;
providing a plurality of permanent magnets wherein each permanent magnet is attached to a planet gear of the plurality of planet gears and inside the chamber of the stator and proximate to the winding sets;
running an electric current in a first direction in the plurality of winding sets such that a first magnetic field is produced creating magnetic forces that are acted upon the plurality of permanent magnets that rotate the plurality of planets gears that in turn causes the central sun gear to also rotate, the plurality of planet gears also revolving around the central sun gear; and
running the electric current in a second direction in the plurality of winding sets such that a second magnetic field is produced creating magnetic forces that are acted upon the plurality of permanent magnets that further rotate the plurality of planets gears that in turn causes the central sun gear to also further rotate, the plurality of planet gears also further revolving around the central sun gear.

17. The method of claim 15, wherein the magnetic forces created by first and second magnetic fields include both attractive forces and repulsive forces.

18. The method of claim 15, wherein lateral sides of the plurality of permanent magnets are attached to the plurality of planet gears.

19. The method of claim 15, wherein the plurality of permanent magnets each have a first magnetic pole proximate to a first width end and a second magnetic pole proximate to a second width end of each permanent magnet.

20. The method of claim 15, wherein the electric current has an alternating square wave form.
